(19) United States
(12) Patent Application Publication
(10) Pub. No.: US 2008/0189756 A1
(43) Pub. Date: Aug. 7, 2008

(54) METHOD FOR PROCESSING FRAMES OF DIGITAL BROADCAST SIGNALS AND SYSTEM THEREOF

(76) Inventor: Yueh-Teng Hsu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/733,182

(22) Filed: Apr. 9, 2007

(30) Foreign Application Priority Data
Feb. 7, 2007 (TW) 096104444

(51) Int. Cl. H04N 7/173

(52) U.S. Cl. 725/133

(57) ABSTRACT

Disclosed are a method for processing a plurality of frames of digital broadcast signals by utilizing a plurality of processor cores and a system thereof. The method includes detecting load of each processor core, determining a specific processor core having a specific load according to loads corresponding to the processor cores, and transmitting at least one frame of the digital broadcast signals to the specific processor core in order to process the frame.

### BACKGROUND OF THE INVENTION

1. Field of the Invention

The invention relates to a method for processing frames and a system thereof, and more particularly, to a method for processing frames of digital broadcast signals by utilizing a plurality of processor cores and a system thereof.

2. Description of the Prior Art

As techniques of video compression have continuously improved, digital TV signals composed of a plurality of frames can broadcast 4-6 standard-definition television (SDTV) programs or one high-definition television (HDTV) program in an existing 6 MHZ TV channel. Compared to traditional analog TV systems, the digital TV system has an improved receiving performance and image quality, and provides bi-directional communication service between suppliers and customers, therefore making the digital TV system play an important role in the development of current global communications.

As well as utilizing a digital TV embedded with a digital receiver to receive digital TV signals, a traditional analog TV can also be utilized to watch digital TV programs by installing a Set Top Box (STB) or a receiver within and setting a specialized digital TV antenna. Additionally, a general personal computer or laptop computer can be connected to a digital receiver via a USB interface to enable a user to watch digital multimedia images directly through a personal computer or laptop computer. Therefore, there is a potential market for using personal or laptop computers to watch digital TV programs.

As the CPU clocks in the personal computer/laptop computer have increased and multi-core processor technology has matured, hardware such as the digital receiver or the Set Top Box (STB) used to perform digital signal processing can be replaced by software. Processing digital signals utilizing software not only can greatly save hardware costs, but also benefits the user by negating the need for any hardware apparatus. Therefore, the present invention provides a method for processing frames by utilizing a plurality of processor cores and a system thereof.

### SUMMARY OF THE INVENTION

One of the objectives of the claimed invention is to provide a method for processing frames of digital broadcast signals by utilizing a plurality of processor cores and a system thereof. The method dynamically allots a plurality of frames to each processor core, and lets the processor core having lower load perform more signal processing in order to balance the load of each core, therefore maximizing the functions of the processor cores. Moreover, when the number of cores increases, the processing speed of the frames also increases in a geometric ratio.

According to an exemplary embodiment of the claimed invention, a method for processing frames of digital broadcast signals by utilizing a plurality of processor cores is disclosed. The method comprises detecting load of each processor core, determining a specific processor core having a specific load according to loads corresponding to the processor cores, and transmitting at least one frame of the plurality of frames to the specific processor core in order to process the frame.

According to an exemplary embodiment of the claimed invention, a system for processing frames of digital broadcast signals by utilizing a plurality of processor cores is disclosed. The system comprises a plurality of processor cores and a storage device. The storage device is coupled to at least one processor core of the plurality of processor cores for storing a program code, wherein the processor core performs the program code to detect load of each processor core, determine a specific processor core having a specific load according to loads corresponding to the processor cores, and transmit at least one frame of the plurality of frames to the specific processor core in order to process the frame.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a system for processing frames by utilizing a plurality of processor cores according to an exemplary embodiment of the invention.

FIG. 2 is a flow chart of a method for processing frames by utilizing a plurality of processor cores according to an exemplary embodiment of the invention.

### DETAILED DESCRIPTION

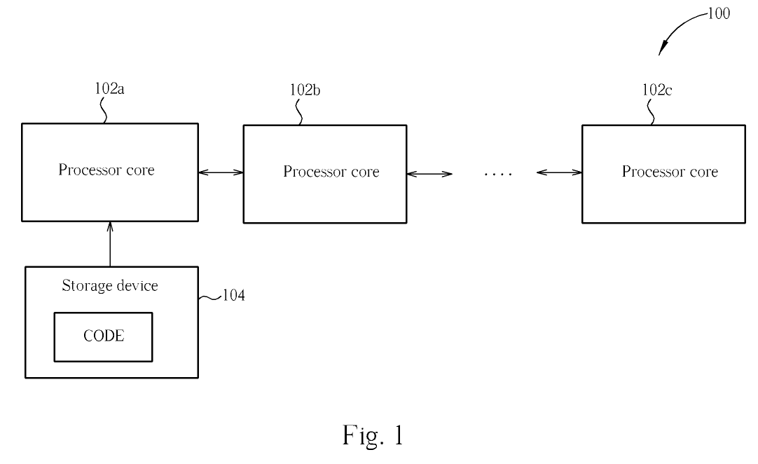

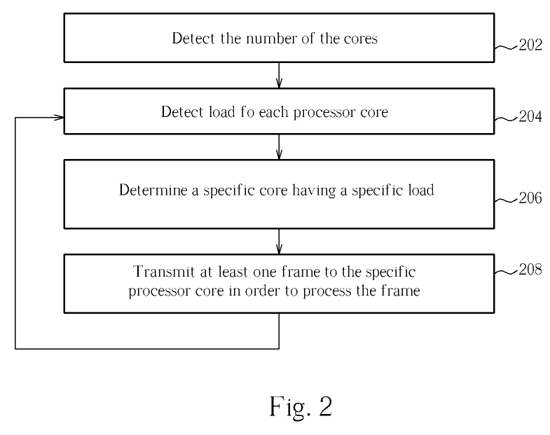

FIG. 1 is a block diagram of a system 100 for processing frames of digital broadcast signals according to an exemplary embodiment of the invention. As shown in FIG. 1, the system 100 comprises a plurality of processor cores 102a, 102b, 102c, and a storage device 104 storing a program code. The storage device 104 is coupled to at least one processor core of the plurality of processor cores 102a, 102b, and 102c. Please note that the plurality of processor cores 102a, 102b, 102c in FIG. 1 are not limited to be built in a same multi-core processor; they can be a plurality of single-core processors, or combinations of multi-core processor and single-core processors. These modified designs all fall within the scope of the invention. Moreover, under the condition of not affecting the disclosure of the invention, FIG. 1 only illustrates three processor cores, however, the number of the processor cores is not limited in the invention. When the system 100 carries out the processing of frames, the system 100 randomly selects a processor core from the processor cores coupled to the storage device 104 to perform the program code. In this embodiment, since the storage device 104 is coupled to the processor core 102a, the program code is performed by the processor core 102a in order to begin the frame processing which will be disclosed in the following. The flow chart of the frame processing is shown in FIG. 2. At first, if the number of processor cores in the system 100 is unknown, the processor core 102a sends a command through the operating system to the processor cores 102a, 102b, 102c to detect the number of cores in the system 100 (step 202). If, however, the number of cores in the system 100 is already known when the frame processing is carried out, step 202 can be omitted. Then, in step 204, the processor core 102a sends a command through the operating system to the processor cores 102a, 102b, 102c to detect load of each processor core. After determining a specific processor core having a specific load (for example, the lowest load) according to the loads corresponding to the processor cores 102a, 102b, 102c (step 206), the processor core 102a transmits at least one frame of the plurality of frames to the specific processor core to process the frame (step 208), and repeats steps 204 to 208 until all frames are processed.

The above-mentioned system and method can be implemented in processing digital broadcast signals, such as digital TV signals. In this embodiment the frames processed by the processor cores 102a, 102b, 102c are extracted from a TV signal, e.g. a digital broadcast signal. In other words, the frames to be processed conform to a TV standard, such as the standard of digital TV. However, the invention is not limited in processing frames of digital TV signals. First the processor core 102a performs the program code stored in the storage device 104. Since the operations of detecting the number and the loads of the processor cores by sending commands of the operating system shown in step 202 and step 204 respectively are familiar to those skilled in the art, the detailed description is omitted here for brevity. After knowing the present load of each processor core, the processor core 102a compares the loads corresponding to the processor cores 102a, 102b, 102c in order to determine a specific processor core having the lowest load, extracts a frame from the TV signal, and transmits the frame to the specific processor core to demodulate the frame. Next, the processor core 102a detects and compares the load of each processor core 102a, 102b, and 102c once more, and transmits the next frame to a processor core having the lowest load at that time in order to process the demodulation procedure. The processor core 102a will repeat the above steps continually until all frames are allotted. The processed frames are multiplexed into a transport stream in order, and the transport stream is transmitted to a decoder to perform the decoding of TV signals. Since the frame header contains the local order of the frame, the demodulated frames can be arranged in order when forming the transport stream to facilitate the decoder to decode the frames. In this embodiment, the processor core processes one frame at a time, but in other embodiments the processor frame can process a plurality of frames at a time; meanwhile, the number of the frames allotted each time is not fixed.

As the TV signal under a current TV broadcast standard is transmitted in the form of frames, the above embodiments regarding a frame as the unit to distribute the signal processing to a plurality of processor cores can successfully maintain the data completeness. Furthermore, allotting more signal processing jobs to the processor cores having lower loads, and allotting less signal processing jobs to the processor cores having higher loads can balance the load of each processor core, therefore maximizing the functions of the processor cores. Compared with a single-core processor, the invention can raise the signal processing speed of a dual-core computer by 50%, and raise the signal processing speed of a qual-core computer by 75%, that is, when the number of cores increase, the processing speed also increases in a geometric ratio, and the processing of the digital TV signals that was conventionally be performed by hardware can be easily completed by software instead.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for processing a plurality of frames of a digital broadcast signal by utilizing a plurality of processor cores, comprising:
detecting load of each processor core;
determining a specific processor core having a specific load according to loads corresponding to the processor cores; and
transmitting at least one frame of the plurality of frames of the digital broadcast signal to the specific processor core having the specific load in order to process the frame.

2. The method of claim 1, wherein the step of determining the specific processor core having the specific load comprises:
comparing the loads corresponding to the processor cores to determine the specific processor core having the specific load;
wherein the specific load is a lowest load among the loads.

3. The method of claim 1, further comprising:
before the step of detecting the load of each processor core, detecting a core number of the plurality of processor cores.

4. The method of claim 3, wherein the core number is detected by sending a command to the plurality of processor cores through an operating system.

5. The method of claim 1, wherein the loads corresponding to the processor cores are detected by sending a command to the plurality of processor cores through an operating system.

6. The method of claim 1, further comprising:
before the step of transmitting at least one frame of the plurality of frames of the digital broadcast signal to the specific processor core having the specific load in order to process the frame, extracting the plurality of frames from the digital broadcast signal.

7. The method of claim 1, wherein the specific processor core performs a demodulation procedure on the frame.

8. The method of claim 1, further comprising:
multiplexing a plurality of frames processed by the processor cores into a transport stream.

9. The method of claim 1, wherein the plurality of processor cores are built in a multi-core processor.

10. The method of claim 9, wherein the multi-core processor is a central processing unit of a computer system.

11. A system for processing a plurality of frames of a digital broadcast signal, comprising:
a plurality of processor cores; and
a storage device, coupled to at least one processor core of the plurality of processor cores, for storing a program code, wherein the processor core performs the program code to detect load of each processor core, determine a specific processor core having a specific load according to loads corresponding to the processor cores, and transmit at least one frame of the plurality of frames of the digital broadcast signal to the specific processor core having the specific load in order to process the frame.

12. The system of claim 11, wherein the processor core performs the program code to compare the loads corresponding to the processor cores in order to determine the specific processor core having the specific load, where the specific load is a lowest load among the loads.

13. The system of claim 11, wherein before detecting the load of each processor core, the processor core further performs the program code to detect a core number of the plurality of processor cores.

14. The system of claim 13, wherein the processor core performs the program code to detect the core number by sending a command to the plurality of processor cores through an operating system.

15. The system of claim 11, wherein the processor core performs the program code to detect the loads corresponding to the processor cores by sending a command to the plurality of processor cores through an operating system.

16. The system of claim 11, wherein before transmitting at least one frame of the plurality of frames of the digital broadcast signal to the specific processor core having the specific load in order to process the frame, the processor core further performs the program code to extract the plurality of frames from the digital broadcast signal.

17. The system of claim 11, wherein the specific processor core performs a demodulation procedure on the frame.

18. The system of claim 1, wherein a plurality of frames processed by the processor cores are multiplexed into a transport stream.

19. The system of claim 11, wherein the plurality of processor cores are built in a multi-core processor.

20. The system of claim 19, wherein the multi-core processor is a central processing unit of a computer system.
